(19) United States
(12) Patent Application Publication
(10) Pub. No.: US 2011/0063068 A1
(43) Pub. Date: Mar. 17, 2011

(54) THERMALLY ACTUATED RF MICROELECTROMECHANICAL SYSTEMS SWITCH

(75) Inventors: Shumin Zhang, Germantown, MD (US); Mona Zaghloul, Bethesda, MD (US); Wansheng Su, Gaithersburg, MD (US); Anis Nurashikin Nordin, Selangor (MY)

(73) Assignee: THE GEORGE WASHINGTON UNIVERSITY, Washington, DC (US)

(21) Appl. No.: 12/828,268

(22) Filed: Jun. 30, 2010

Related U.S. Application Data
(60) Provisional application No. 61/243,187, filed on Sep. 17, 2009.

(51) Int. Cl. H01H 37/02

(52) U.S. Cl. 337/35

(57) ABSTRACT

A radio frequency (RF) micro electromechanical system (MEMS) switch formed on a substrate (e.g., a CMOS substrate). The RF MEMS switch includes a micromechanical member including a flexible switch membrane configured to move between an on state and an off state of the RF MEMS switch. The flexible switch membrane includes a first set of fingers on a sidewall thereof to be vertically coupled with a second set of fingers formed at an output of the RF MEMS switch on the substrate, and an actuation member in operable communication with the micromechanical member and configured to thermally actuate the micromechanical member such that the first set of fingers electrically couple with the second set of fingers upon thermal actuation of the micromechanical member to enable transmission of an RF signal.

### CROSS REFERENCE TO RELATED APPLICATIONS

This application claims the benefit of U.S. Provisional Patent Application No. 61/243,187 filed on Sep. 17, 2009 which is incorporated by reference herein in its entirety.

### BACKGROUND

This invention relates to micro electromechanical systems (MEMS) switches, and more particularly to a thermally actuated radio frequency (RF) MEMS switch.

RF MEMS switches have been used extensively in configurable circuits, antennas, and other RF applications. Examples of conventional MEMS switches include a Direct Current (DC) contact type switch and a capacitive type switch. The contact type switch is typically used for switching signal from DC to 60 GHz while capacitive switches are used for switching RF signals ranging between 6 GHz to approximately 120 GHz. FIG. 1A is a diagram illustrating a typical cantilever beam RF MEMS switch. As shown in FIG. 1A, the RF MEMS switch 1 includes a cantilever beam 2 anchored to a substrate 4 via an anchor 6. The cantilever beam 2 is pulled down by the use of a DC electrode 8 positioned beneath the cantilever beam 2. When in an on-position, the cantilever beam 2 makes a metal-to-metal contact with an RF transmission line 10 as shown in FIG. 1A. FIG. 1B is a diagram illustrating a conventional capacitive shunt switch in an on-position. As shown in FIG. 1B, the switch 25 is formed on a substrate 12 and includes a lower electrode and a dielectric layer 15 formed on the lower electrode. A flexible bridge member 19 is anchored via two posts 20 positioned at an input 13 and an output 14. The flexible bridge member 19 bends due to electrostatic actuation and the capacitance of the switch 25 changes between on and off states.

There are several problems associated with these types of switches. For example, the DC contact type switch has contact failures that include increased contact resistance from contamination build-up and shorting failures from micro-welding of the contacts. The capacitive type switch has problems such as the on-off ratio of the switch capacitance is limited by a small distance between two electrodes. The capacitive type switch also has problems with substrate loss and down-state capacitance degradation.

### SUMMARY

To solve the above-identified problems, the present invention provides a low voltage thermally actuated RF MEMS switch and a thermal actuation method used to achieve a reliable, low-voltage switch operation.

According to an embodiment of the present invention, a radio frequency (RF) micro electromechanical system (MEMS) switch formed on a substrate. The RF MEMS switch includes a micromechanical member including a flexible switch membrane configured to move between an on state and an off state of the RF MEMS switch. The flexible switch membrane includes a first set of fingers on a sidewall thereof to be vertically coupled with a second set of fingers formed at an output of the RF MEMS switch on the substrate. The switch further includes an actuation member in operable communication with the micromechanical member and configured to thermally actuate the micromechanical member such that the first set of fingers electrically couple with the second set of fingers upon thermal actuation of the micromechanical member to enable transmission of an RF signal.

According to another embodiment of the present invention, a method for actuating a radio frequency (RF) micro electromechanical system (MEMS) switch formed on a substrate is provided. The method includes thermally actuating a micromechanical member having a first set of fingers on a sidewall thereof, and vertically coupling the first set of fingers with a second set of fingers formed at an output of the RF MEMS switch on the substrate based on the thermal actuation, to move the RF MEMS switch into an on state, thereby enabling transmission of an RF signal.

According to another embodiment of the present invention, a method for fabricating a radio frequency (RF) micro electromechanical system (MEMS) switch on a semiconductor substrate is provided. The method includes forming a plurality of dielectric layers and metal layers between the dielectric layers adjacent to semiconductor circuitry formed on an upper surface of the semiconductor substrate and etching of exposed dielectric material of the dielectric layers formed to form structural side walls of the switch. The structural side walls including a micromechanical member including a plurality of fingers on a sidewall of the micromechanical member to be vertically coupled with fingers formed on the semiconductor substrate. The method further includes depositing of an oxide layer on the structure sidewalls of the switch, and removing a portion of the semiconductor substrate beneath the micromechanical member to release the micromechanical member formed.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A and 1B are diagrams illustrating conventional RF MEMS switch.

FIG. 2 is a diagram illustrating a RF MEMS switch that can be implemented within embodiments of the present invention.

FIG. 3 is a top view illustrating the RF MEMS switch shown in FIG. 2.

FIGS. 4A and 4B are top views, respectively, illustrating an off-position and an on-position of the RF MEMS switch shown in FIGS. 2 and 3 that can be implemented within embodiments of the present invention.

FIG. 5 is a diagram illustrating the multiple layers of the RF MEMS switch shown in FIGS. 2 and 3 that can be implemented within embodiments of the present invention.

FIGS. 6A through 6E are diagrams illustrating a fabrication process of the RF MEMS switch shown in FIGS. 2 and 3 before a final releasing operation.

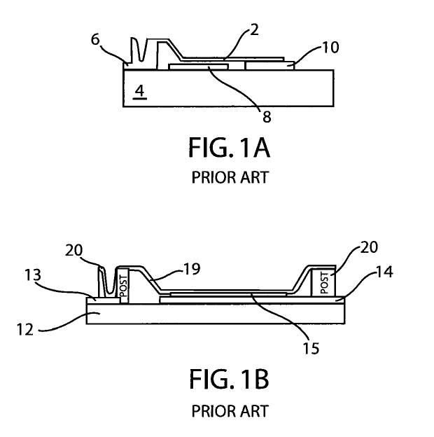

The detailed description explains the preferred embodiments of the invention together with advantages and features, by way of example with reference to the drawings.

### DETAILED DESCRIPTION

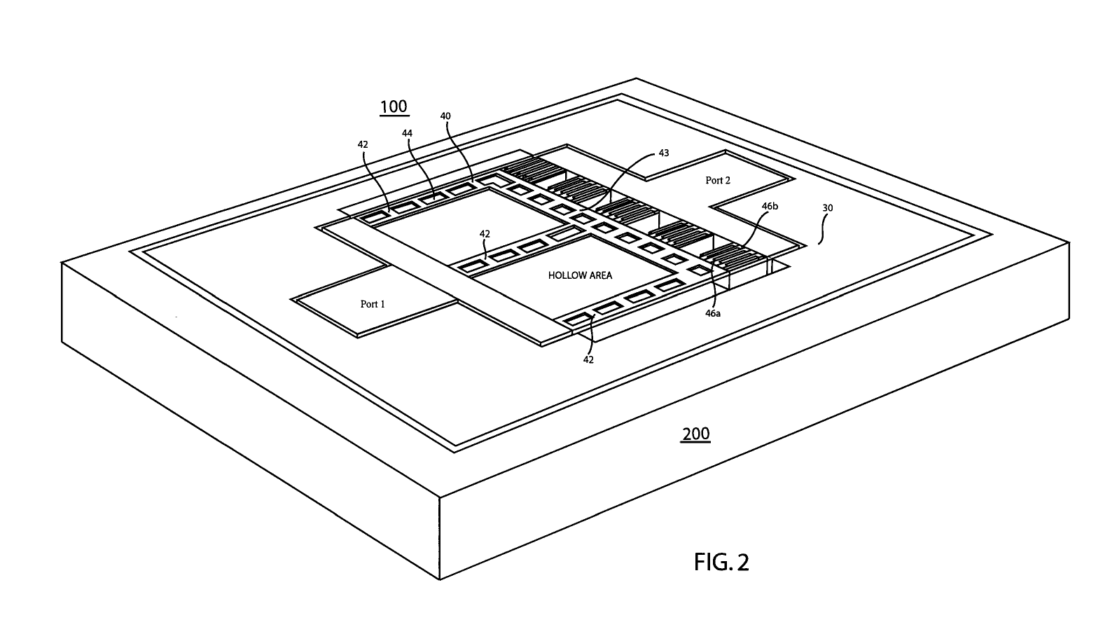

Turning now to the drawings in greater detail, it will be seen that FIG. 2 illustrates a radio frequency (RF) microelectromechanical system (MEMS) switch 100 that can be implemented within embodiments of the present invention. In FIG. 2, the RF MEMS switch 100 is formed on a substrate 200, i.e., a complementary metal-oxide semiconductor (CMOS) substrate, for example. However, the present invention is not limited to a CMOS substrate and may be vary as necessary. According to an embodiment of the present invention, the RF MEMS switch 100 is an alternative to a CMOS switch.

According to an embodiment of the present invention, the RF MEMS switch 100 is a vertical switch having sidewall coupling for capacitive switching. That is, the RF MEMS switch 100 is a vertically displaceable device which remains parallel to the substrate 200 and is rotatable with respect to the substrate 200. The RF MEMS switch 100 may be utilized in band-configurable RF circuits such as configurable voltage-controlled oscillators (VCOs) and matching networks where the switch 100 can be used to change the value of the matching network to make it match different frequency points. In addition, the RF MEMS switch 100 may be utilized in configurable filtering arrays, and configurable antenna arrays.

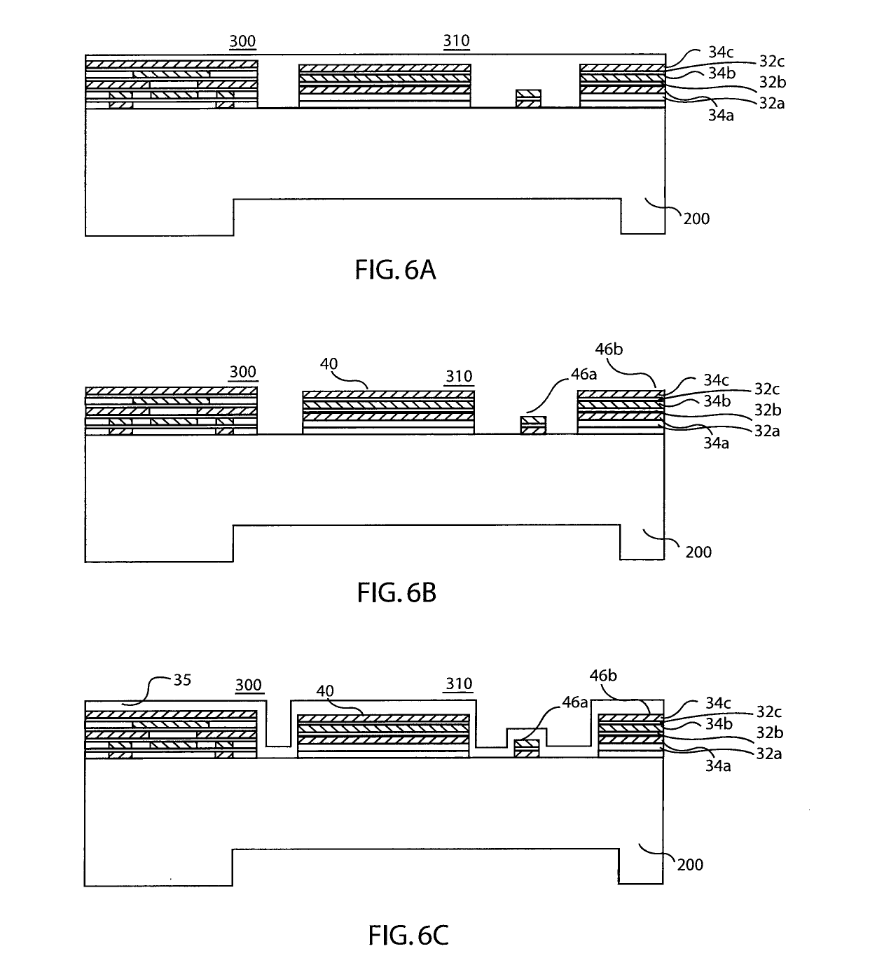

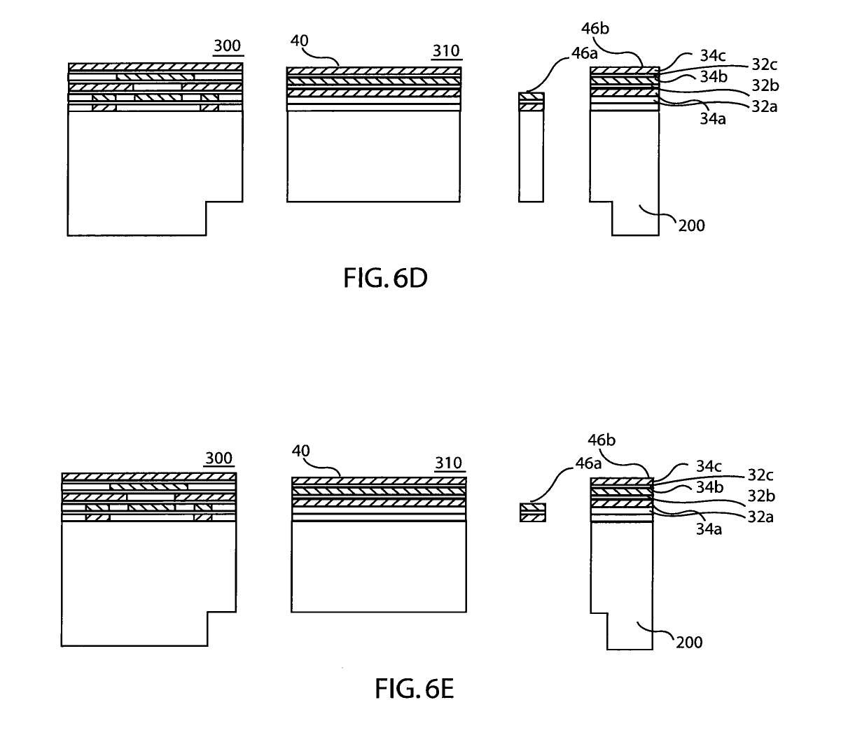

According to an embodiment of the present invention, the RF MEMS switch 100 includes a ground plane 30 formed on the substrate 200. The ground plane 30 has generally a rectangular shape. The ground plane 30 includes a plurality of metal layers (to be discussed below with reference to FIG. 6). A RF inputting end (i.e., Port 1) and a RF outputting end (i.e., Port 2) are also provided. The plurality of metal layers of the ground plane 30 is etched to form RF inputting end and RF outputting end. The RF inputting end is electrically isolated from the ground plane 30 and the RF MEMS switch 100 is anchored at one side (e.g., at Port 1) to the substrate 200, for example. As shown in FIG. 2, the RF MEMS switch 100 is etched such that beneath the RF MEMS switch 100, a hollow area can be seen where bulk silicon of the substrate 200 has been removed (to be discussed later below).

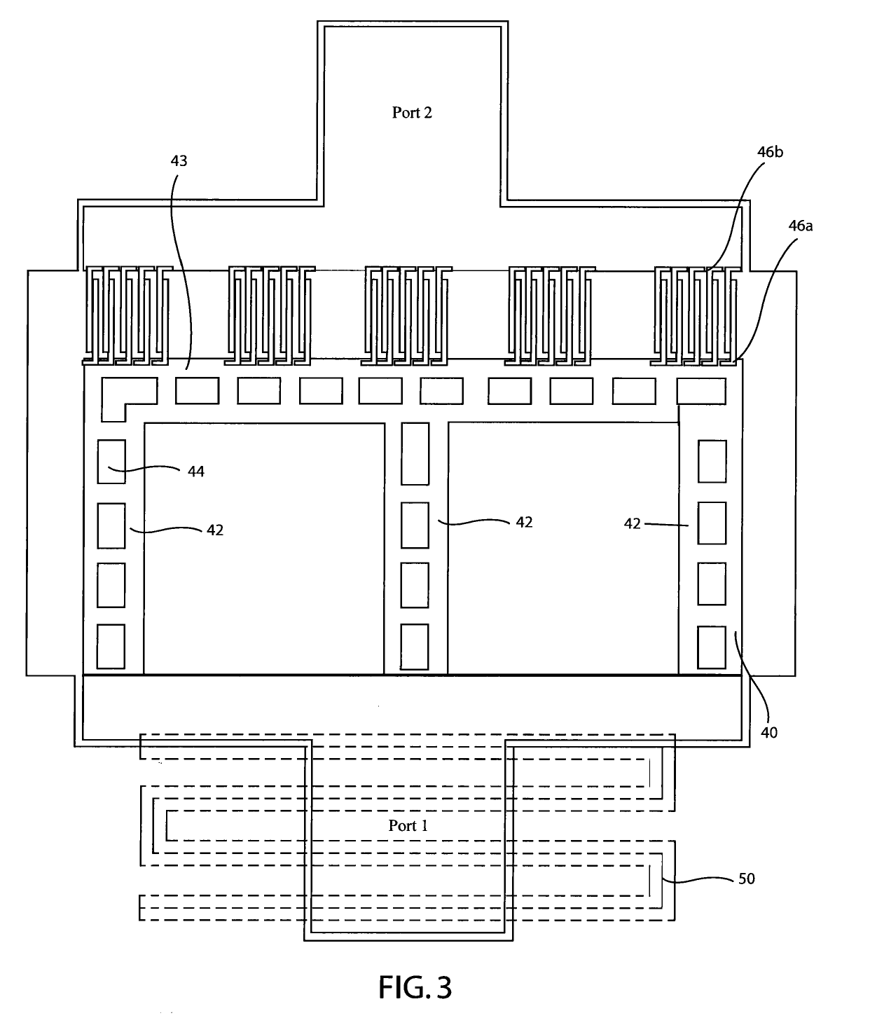

The RF MEMS switch 100 further includes a micromechanical member (i.e., a flexible switch membrane 40) configured to be thermally actuated between an on position and an off position of the RF MEMS switch 100. The RF MEMS switch 100 may be thermally actuated by sending an electrical current to a heating element as discussed below with reference to FIG. 3. The on position corresponds to an on-state of the switch 100 wherein the transmission line is closed and can be used for transmitting a RF signal. The off position corresponds to an off-state of the switch 100 where the transmission line is open and may not be used for transmitting a RF signal.

Further, the flexible switch membrane 40 is a floating beam that can freely move between both the on-position and off-position in a direction that is perpendicular to the substrate 200. According to an embodiment of the present invention, the flexible switch membrane 40 comprises a plurality of bimorph beams 42 integrally combined and each comprising a plurality of vias 44 to facilitate a release of the flexible switch membrane 40 from the substrate 200 formed beneath the RF MEMS switch 100. According to the current embodiment of the present invention, the plurality of bimorph beams 42 together forms an H-shape. Therefore, the RF MEMS switch 100 is in the form of an H-shape. However, the present invention is not limited to an H-shape and the shape may be varied accordingly.

The flexible switch membrane 40 comprises a first set of elongated fingers 46a on a sidewall 43 thereof for vertical coupling with a second set of fingers 46b formed at the RF outputting end (i.e., Port 2) of the RF MEMS switch 100. According to an embodiment of the present invention, the first set of fingers 46a are arranged generally parallel to one another at spaced-apart positions and respectively attached to the sidewall 43 of the flexible switch membrane 40. Likewise, the second set of fingers 46b are arranged parallel to one another at spaced-apart positions and respectively attached to the RF outputting end on the substrate 200. That is, the second set of fingers 46b are fixed onto the substrate 200 at the RF outputting end.

According to an embodiment of the present invention, a number of fingers in the first set of fingers 46a are equal to that of the second set of fingers 46b. As shown in FIGS. 2 and 3 the first and second sets of fingers 46a and 46b each comprises a total of 25 fingers. Further, as shown in FIG. 2, the first set of fingers 46a and the second set of fingers 46b each comprise groups of fingers. Thus, in the current embodiment of the present invention, the first and second sets of fingers 46a and 46b each include five (5) groups of five (5) fingers (totaling 25 fingers in each set of fingers 46a and 46b). Further, a predetermined gap is formed between each finger of the first and second set of fingers 46a and 46b and each finger 46a, 46b is of a predetermined thickness.

According to an embodiment of the present invention, the number of fingers 46a and 46b may vary. According to an embodiment of the present invention, the fingers 46a and 46b may include between one to thousands, for example therefore the capacitance of the switch 100 is linearly configurable. For example, if the switch 100 includes six fingers 46a, 46b then the predetermined gap may be approximately 2 μm and the thickness may be approximately 4.2 μm. Thus, according to an embodiment of the present invention, the capacitance in the on state is approximately 1.02 pf while the capacitance in the off state is approximately 0.17 pf. On the other hand, if the switch 100 includes 12 fingers 46a, 46b and a predetermined gap of approximately 2 μm and the thickness of approximately 4.2 μm, the capacitance in the on state may be approximately 2 pf while the capacitance in the off state may be approximately 0.29 pf. Thus, the capacitance is configurable by changing the number of fingers 46a, 46b provided.

According to one embodiment of the present invention, further, as shown in FIG. 3, the RF MEMS switch 100 further includes an actuation member 50 configured to thermally actuate the flexible switch membrane 40. The actuation member 50 is provided at RF inputting end. According to an embodiment of the present invention, the actuation member 50 may be a polysilicon heater however the present invention is not limited hereto and any suitable thermal heating device may be used.

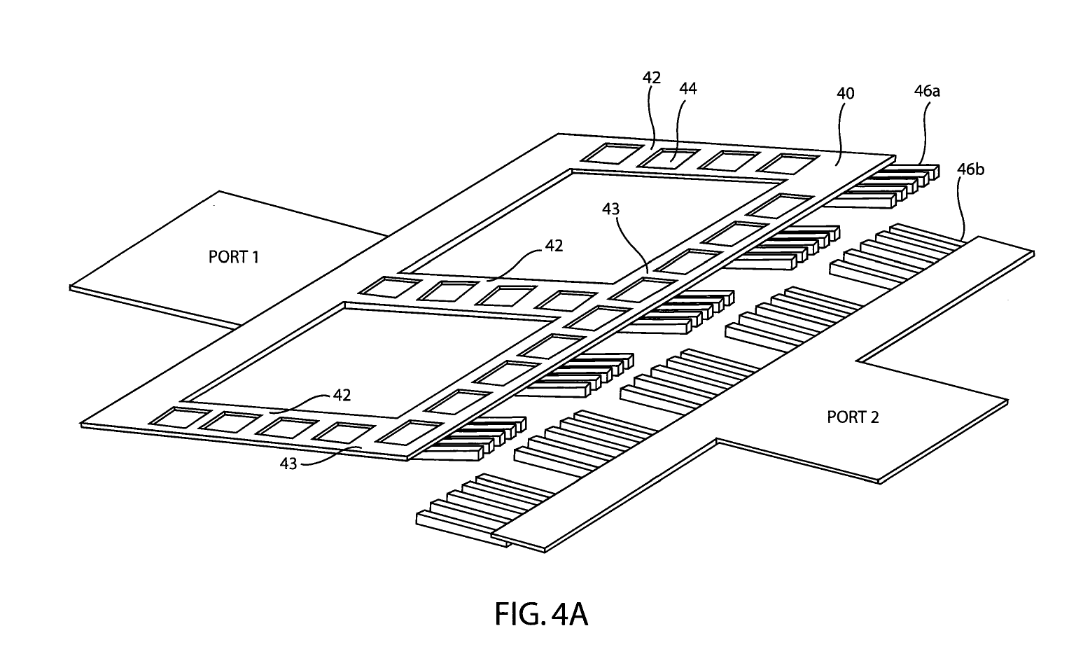

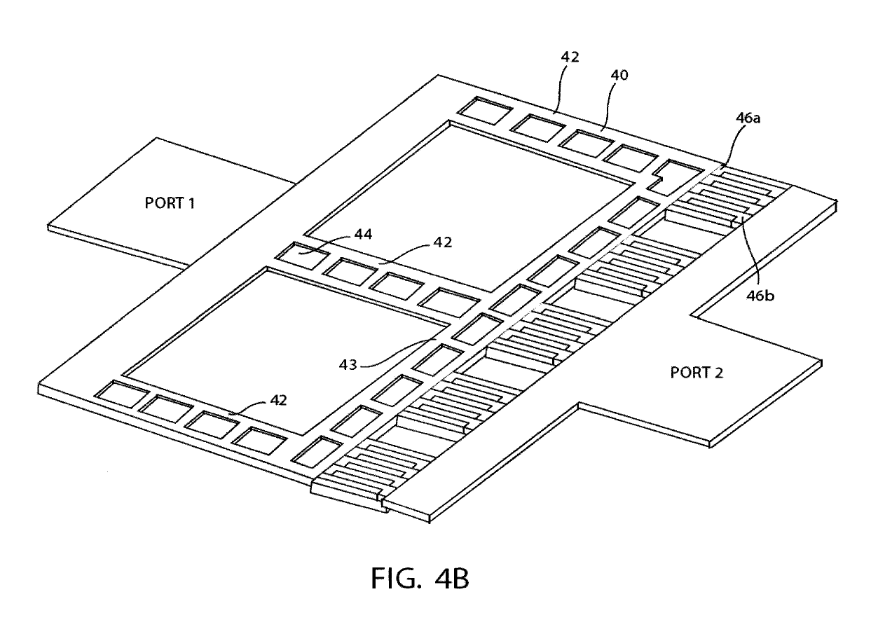

According to an embodiment of the present invention, the first set of fingers 46a are electrically coupled with the second set of fingers 46b upon thermal actuation of the flexible switch membrane 40. An on position and an off position of the RF MEMS switch 100 will now be discussed below with reference to FIGS. 4A and 4B.

FIGS. 4A and 4B are top views, respectively, illustrating an off-position and an on-position of the RF MEMS switch 100 shown in FIGS. 2 and 3 that can be implemented within embodiments of the present invention. As shown in FIG. 4A, when in an off position, the flexible switch membrane 40 is tilted upward in a position parallel to the substrate 200 such that the transmission line is open and an RF signal may not be transmitted. As shown in FIG. 4B, when thermally actuated via the actuation member 50, electrical current is applied and causes the flexible switch membrane 40 to bend downward. The bending action causes the flexible switch membrane 40 to tilt relative to the substrate 200 and the fingers 46a and 46b become interdigitated such that the transmission line is in a closed position to allow the transmission of an RF signal. According to an embodiment of the present invention, the displacement of the flexible switch membrane 40 is determined by temperature variation caused by electrical heating.

As an alternative embodiment of the present invention, thermal actuation may be used to turn on the switch 100 and an electrical field (i.e., DC voltage) is used to hold the switch 100 at in the on position. In this embodiment, no DC current is required after the switch 100 is turned on and the overall power consumption may be reduced.

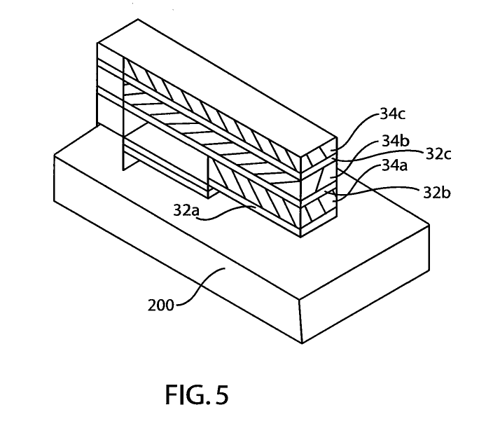

As mentioned above, the ground plane 30 is formed of a plurality of metal layers. FIG. 5 is a diagram illustrating an example of the multiple layers of ground plane 30 of the RF MEMS switch 100. As shown in FIG. 5, the ground plane 30 may include, for example, three dielectric layers (e.g., silicon oxide (SiO₂) layers 32a, 32b and 32c) and three metal layers (e.g., aluminum layers 34a, 34b, and 34c) however the present invention is not limited hereto, the number of layers may vary, accordingly. Since the dielectric layers 32a, 32b and 32c are of a material having a different thermal coefficient of expansion than that of the metal layers 34a, 34b and 34c, the flexible switch membrane 40 bends from the heat upon thermal actuation. A fabrication process will now be described below with reference to FIGS. 6A through 6E.

FIGS. 6A through 6E are diagrams illustrating a fabrication process of the RF MEMS switch before a final releasing operation. According to an embodiment of the present invention, the RF MEMS switch 100 is CMOS process-compatible and uses a two step maskless reactive ion etching (RIE) technique for post-processing. The top-level metal is used as an etch-resistant mask to define the RF MEMS switch 100. The RF MEMS switch 100 may be manufactured by using conventional surface micromachining technologies (i.e., by depositing and patterning several layers on a wafer).

As shown in FIG. 6A, CMOS circuitry 300 is formed on an upper surface of the silicon (Si) substrate 200 and the ground plane 30 (i.e., microstructural region 310) is disposed on the silicon (Si) substrate 200. As mentioned above with reference to FIG. 5, the ground plane 30 may include three dielectric layers (e.g., silicon dioxide (SiO₂) layers 32a, 32b and 32c) and three metal layers 34a, 34b and 34c formed of Aluminum (Al), for example. Alternatively, the metal layers 34a, 34b and 34c may be formed of silicon germanium (SiGe), for example. A layer of polysilicon may be formed at an upper surface of the substrate 200. A backside silicon deep reactive ion etching (RIE) operation and controls the thickness of the switch 100 and forms a cavity that allows the switch 100 to move freely. The multiple metal layer structure is etched to form the RF MEMS switch 100 in FIGS. 6B through 6E. That is, the RF inputting and outputting ends (e.g., Ports 1 and 2) and the flexible switch membrane 40, the fingers 46a and 46b as shown in FIGS. 2 and 3 are etched.

In FIG. 6B, next, exposed dielectric material (e.g., SiO₂) of the dielectric layers 32a, 32b and 32c not covered by a top level metal layer is removed via an anisotropic reactive ion etching (RIE) process to form structural side walls of the switch 100. That is, this etching process forms the flexible switch membrane 40 and the fingers 46a and 46b.

In FIG. 6C, according to an embodiment of the present invention, an oxide material 35 such as silicon dioxide (SiO₂) is deposited along the side walls via a conformal plasma enhanced chemical deposition (PECVD) process, for example. This operation increases the impedance between the two electrodes.

In FIG. 6D, the silicon (Si) is then etched to expose Si beneath the flexible switch membrane 40 and in between the groups of fingers 46a and 46b using CHF₃/O₂ (for etching SiO₂).

In FIG. 6E, an isotropic RIE process using SF6 plasma or XeF2 is then used to remove the bulk silicon of the substrate 200 to release the flexible switch membrane 40.

Embodiments of the present invention provide a thermally actuated RF MEMS switch that is CMOS process compatible and provides linearly configurable capacitance by changing the number of fingers of the switch, thereby increasing the on/off capacitance ratio of the switch.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A radio frequency (RF) micro electromechanical system (MEMS) switch formed on a substrate, the RF MEMS switch comprising:
a micromechanical member including a flexible switch membrane configured to move between an on state and an off state of the RF MEMS switch, the flexible switch membrane comprising a first set of fingers on a sidewall thereof to be vertically coupled with a second set of fingers formed at an output of the RF MEMS switch on the substrate; and
an actuation member in operable communication with the micromechanical member and configured to thermally actuate the micromechanical member such that the first set of fingers electrically couple with the second set of fingers upon thermal actuation of the micromechanical member to enable transmission of an RF signal.

2. The RF MEMS switch of claim 1, wherein the flexible switch membrane comprises:
a plurality of bimorph beams integrally combined and each comprising a plurality of vias to facilitate a release of the flexible switch membrane from the substrate formed beneath the RF MEMS switch.

3. The RF MEMS switch of claim 2, wherein the plurality of bimorph beams together form an H-shape.

4. The RF MEMS switch of claim 3, wherein the actuation member is a polysilicon heater.

5. The RF MEMS switch of claim 1, wherein a number of fingers in the first set of fingers are equal to that of the second set of fingers.

6. The RF MEMS switch of claim 5, wherein the first set of fingers and the second set of fingers each comprise groups of fingers.

7. The RF MEMS switch of claim 1, wherein a predetermined gap is formed between each finger of the first and second set of fingers.

8. The RF MEMS switch of claim 1, wherein each finger is of a predetermined thickness.

9. The RF MEMS switch of claim 1, wherein the second set of fingers is fixed to the substrate.

10. The RF MEMS switch of claim 1, wherein the substrate is a Complementary metal-oxide-semiconductor (CMOS) substrate.

11. A method for actuating a radio frequency (RF) micro electromechanical system (MEMS) switch formed on a substrate, the method comprising:
thermally actuating a micromechanical member having a first set of fingers on a sidewall thereof; and
vertically coupling the first set of fingers with a second set of fingers formed at an output of the RF MEMS switch on the substrate based on the thermal actuation, to move the RF MEMS switch into an on state, thereby enabling transmission of an RF signal.

12. The method of claim 11, wherein the semiconductor substrate is a Complementary metal-oxide-semiconductor (CMOS) substrate.

13. A method for fabricating a radio frequency (RF) micro electromechanical system (MEMS) switch on a semiconductor substrate, the method comprising:
forming a plurality of dielectric layers and metal layers between the dielectric layers adjacent to semiconductor circuitry formed on an upper surface of the semiconductor substrate;
etching of exposed dielectric material of the dielectric layers formed to form structural side walls of the switch including a micromechanical member including a plurality of fingers on a sidewall of the micromechanical member to be vertically coupled with fingers formed on the semiconductor substrate;
depositing of an oxide layer on the structure sidewalls of the switch; and
removing a portion of the semiconductor substrate beneath the micromechanical member to release the micromechanical member formed.

14. The method of claim 13, wherein the semiconductor substrate is a Complementary metal-oxide-semiconductor (CMOS) substrate.
